(19) United States
(12) Patent Application Publication
(10) Pub. No.: US 2026/0149527 A1
(43) Pub. Date: May 28, 2026

(54) SIGNAL PROCESSING CIRCUIT, RECEIVER, AND SIGNAL PROCESSING METHOD

(71) Applicant: NEC Corporation, Tokyo (JP)

(72) Inventor: Manabu Arikawa, Tokyo (JP)

(73) Assignee: NEC Corporation, Tokyo (JP)

(21) Appl. No.: 19/398,263

(22) Filed: Nov. 24, 2025

(30) Foreign Application Priority Data
Nov. 28, 2024 (JP) 2024-207336

(51) Int. Cl. H04J 14/00; H04B 10/61

(52) U.S. Cl. CPC H04J 14/052; H04B 10/6161; H04B 10/6162

(57) ABSTRACT

A signal processing circuit includes a MIMO demodulation unit that includes a first MIMO filter and performs MIMO demodulation processing on a plurality of signals, a signal extraction unit that extracts a signal of a predetermined time slot from an output signal of the MIMO demodulation unit, a removal component generation unit that includes a second MIMO filter and generates a signal component to be removed including an interference component generated between modes, an interference cancellation unit that generates a signal in which the signal component to be removed has been removed from the signal extracted by the signal extraction unit, and a coefficient control unit that adaptively controls coefficients of the first MIMO filter and the second MIMO filter using a magnitude of a difference between the signal in which the signal component to be removed has been removed and a reference signal as a loss function.

### INCORPORATION BY REFERENCE

This application is based upon and claims the benefit of priority from Japanese patent application No. 2024-207336, filed on Nov. 28, 2024, the disclosure of which is incorporated herein in its entirety by reference.

### TECHNICAL FIELD

The present disclosure relates to a signal processing circuit, a receiver, a signal processing method, and a program.

### BACKGROUND ART

In optical fiber communication using a single mode fiber (SMF), a signal to noise ratio of a signal cannot be increased without limitation due to a non-linear effect or a fiber fuse phenomenon. Thus, there is a limit to increasing capacity of optical fiber communication using the SMF. As a technique for implementing further increasing the capacity of optical fiber communication, a spatial multiplexing transmission technique has attracted attention. In the spatial multiplexing transmission technique, signals are multiplexed by utilizing a degree of freedom of a space in an optical fiber.

An optical transmission system in which the spatial multiplexing transmission technique is used, that is, a spatial multiplexing optical transmission system is roughly divided into an uncoupled system and a coupled system according to a magnitude of coupling between spatial channels. The uncoupled system is a system in which coupling between spatial channels is small. In the uncoupled system, an existing optical transceiver for the SMF optical transmission system can be used as it is. However, in general, there is a trade-off relationship between density of the spatial channels and the magnitude of coupling between the spatial channels. Thus, there is a limit to spatial multiplexing to be implemented.

On the other hand, in the coupled system, coupling between spatial channels is allowed. In the coupled system, coupling between spatial channels is compensated for, typically on a receiver side, using multi input multi output (MIMO) signal processing. In the coupled system, an optical receiver using MIMO signal processing is required, but larger spatial channel density, that is, larger transmission capacity per optical fiber is achieved. A coupled spatial multiplexing optical transmission system will be described below.

FIG. 9 is a block diagram illustrating a receiver-side MIMO signal processing circuit in a coupled spatial multiplexing transmission system. The receiver-side MIMO signal processing circuit illustrated in FIG. 9 is described in S. Randel et al., “6×56-Gb/s mode-division multiplexed transmission over 33-km few-mode fiber enabled by 6×6 MIMO equalization”, Opt. Express 19 (17), 16697 (2011), for example. In a case where the number of modes obtained by combining a polarization mode and a spatial mode is n, the number of input/output signals of the MIMO signal processing circuit is n. In FIG. 9, two input/output signals are used for ease of viewing of the drawing.

A MIMO signal processing circuit 200 includes a MIMO filter 210 and a carrier phase compensation filter 220. In the example of FIG. 9, the MIMO filter 210 is configured as 2×2 MIMO. A complex signal corresponding to each space and each polarization mode, which is coherently detected and in which wavelength dispersion of a transmission path, and the like, are compensated, is input to the MIMO filter 210. As the MIMO filter 210, a linear and time domain finite impulse response (FIR) filter or a frequency domain filter is used. Coefficients of the MIMO filter 210 are adaptively controlled in such a way as to compensate for coupling between the spatial mode and the polarization mode during transmission and a propagation delay difference, that is, mode dispersion. The carrier phase compensation filter 220 performs carrier phase compensation on the signal output from the MIMO filter 210.

A coefficient control unit 230 adaptively updates coefficients of the MIMO filter 210 in such a way that an output signal of the carrier phase compensation filter 220 has desired characteristics. As a well-known coefficient updating method, there is a method using a stochastic gradient descent method. As such a method, constant modulus algorithm (CMA) and least mean squares (LMS) are known. In a case where CMA is used, the coefficient control unit 230 configures a loss function to be minimized from a magnitude of a difference between an amplitude of the output signal of the carrier phase compensation filter 220 and a reference amplitude. In a case of LMS, the coefficient control unit 230 configures a loss function to be minimized from a magnitude of a difference between the output signal of the carrier phase compensation filter 220 and a training signal or a symbol after determination. In either method, the coefficient control unit 230 calculates a gradient related to filter coefficients of the loss function using the input/output signal of the MIMO filter 210 and a calculation result of carrier phase compensation (not illustrated in FIG. 9 for readability) in order to update the coefficients by a gradient descent method. As a result of the coefficients of the MIMO filter 210 being adaptively controlled to compensate for coupling between the modes and mode dispersion, a plurality of multiplexed and transmitted signals coupled in the transmission path is separated.

### SUMMARY

In a general coupled spatial multiplexing optical transmission system, it is known that a mode-dependent loss generated during transmission is a factor of performance degradation. In order to alleviate influence of the mode-dependent loss, MIMO signal processing using repetition processing has been studied (for example, K. Shibahara et al., “DMD-unmanaged long-haul SDM transmission over 2500-km 12core×3-mode MC-FMF and 6300-km 3-mode FMF employing intermodal interference cancelling technique”, Journal of Lightwave Technology 37 (1), 138 (2019)). “DMD-unmanaged long-haul SDM transmission over 2500-km 12core×3-mode MC-FMF and 6300-km 3-mode FMF employing intermodal interference cancelling technique” describes a method of successive interference canceller in which a multi-input single-output (MISO) filter in which an output thereof is added to a next input is repeatedly applied. However, in general, the method using such repetitive processing has problems that a calculation amount is large and a calculation delay is large.

An example object of the present disclosure is to provide a signal processing circuit, a receiver, a signal processing method, and a program capable of alleviating degradation in performance caused by a mode-dependent loss without greatly increasing a calculation amount even in a case where an input signal has the mode-dependent loss.

A signal processing circuit according to a first example aspect of the present disclosure includes a MIMO demodulation unit that includes a first MIMO filter and performs MIMO demodulation processing on a plurality of signals corresponding to a plurality of modes, a signal extraction unit that extracts a signal of a predetermined time slot from an output signal output from the MIMO demodulation unit, a removal component generation unit that includes a second MIMO filter and generates a signal component to be removed including an interference component generated between the plurality of modes based on the signal output from the MIMO demodulation unit, an interference cancellation unit that generates a signal in which the signal component to be removed has been removed from the signal extracted by the signal extraction unit, and a coefficient control unit that adaptively controls coefficients of the first MIMO filter and coefficients of the second MIMO filter using an error back propagation method and a gradient descent method using a magnitude of a difference between the signal in which the signal component to be removed has been removed and a reference signal as a loss function.

A receiver according to a second example aspect of the present disclosure includes the signal processing circuit and a coherent receiver that coherently receives the plurality of signals.

A signal processing method according to a third example aspect of the present disclosure includes performing MIMO demodulation processing on a plurality of signals corresponding to a plurality of modes using a first multi input multi output (MIMO) filter, extracting a signal of a predetermined time slot from an output signal of the MIMO demodulation processing, generating a signal component to be removed including an interference component generated between the plurality of modes using a second MIMO filter based on the output signal subjected to the MIMO demodulation, generating a signal in which the signal component to be removed has been removed from the extracted signal, and adaptively controlling coefficients of the first MIMO filter and coefficients of the second MIMO filter using an error back propagation method and a gradient descent method using a magnitude of a difference between the signal in which the signal component to be removed has been removed and a reference signal as a loss function.

A program according to a fourth example aspect of the present disclosure causing a processor to execute processing of performing MIMO demodulation processing on a plurality of signals corresponding to a plurality of modes using a first multi input multi output (MIMO) filter, extracting a signal of a predetermined time slot from an output signal of the MIMO demodulation processing, generating a signal component to be removed including an interference component generated between the plurality of modes using a second MIMO filter based on the output signal subjected to the MIMO demodulation, generating a signal in which the signal component to be removed has been removed from the extracted signal, and adaptively controlling coefficients of the first MIMO filter and coefficients of the second MIMO filter using an error back propagation method and a gradient descent method using a magnitude of a difference between the signal in which the signal component to be removed has been removed and a reference signal as a loss function.

The signal processing circuit, the receiver, the signal processing method, and the program according to the present disclosure can alleviate degradation in performance caused by a mode-dependent loss without greatly increasing a calculation amount.

### BRIEF DESCRIPTION OF DRAWINGS

FIG. 1 is a block diagram illustrating an example of a schematic configuration of a receiver according to the present disclosure;

FIG. 2 is a block diagram illustrating a configuration example of a signal transmission system according to the present disclosure;

FIG. 3 is a block diagram illustrating a configuration example of an optical transmitter;

FIG. 4 is a block diagram illustrating a configuration example of an optical receiver;

FIG. 5 is a block diagram illustrating a configuration example of a MIMO signal processing circuit;

FIG. 6 is a flowchart indicating operation procedure of the MIMO signal processing circuit;

FIG. 7 is a graph indicating an evaluation result of BER before error correction obtained by simulation;

FIG. 8 is a block diagram illustrating a configuration example of a signal processing circuit; and

FIG. 9 is a block diagram illustrating a receiver-side MIMO signal processing circuit.

### EXAMPLE EMBODIMENT

Prior to describing example embodiments of the present disclosure, outline of the present disclosure will be described. FIG. 1 is a block diagram illustrating an example of a schematic configuration of a receiver according to the present disclosure. The receiver 10 includes a coherent receiver 20 and a signal processing circuit 30. The signal processing circuit 30 includes a MIMO demodulation unit 31, a signal extraction unit 32, a removal component generation unit 33, an interference cancellation unit 34, and a coefficient control unit 35.

The MIMO demodulation unit 31 includes a first MIMO filter, and performs MIMO demodulation processing on a plurality of signals corresponding to a plurality of modes. An output signal of the MIMO demodulation processing is branched into the signal extraction unit 32 and the removal component generation unit 33. The signal extraction unit 32 extracts a signal of a predetermined time slot from the output signal output from the MIMO demodulation unit 31. The removal component generation unit 33 includes a second MIMO filter. The removal component generation unit 33 generates a signal component to be removed including an interference component generated between a plurality of modes based on the signal output from the MIMO demodulation unit 31.

The interference cancellation unit 34 generates a signal in which the signal component to be removed generated by the removal component generation unit 33 has been removed from the signal extracted by the signal extraction unit 32. The coefficient control unit 35 controls coefficients of the first MIMO filter included in the MIMO demodulation unit 31 and coefficients of the second MIMO filter included in the removal component generation unit 33. The coefficient control unit 35 adaptively controls the coefficients of the first MIMO filter and the coefficients of the second MIMO filter using an error back propagation method and a gradient descent method using a magnitude of a difference between the signal in which the signal component to be removed has been removed and a desired reference signal as a loss function.

In the present disclosure, the MIMO demodulation unit 31 removes coupling between modes that may occur in the plurality of signals using the first MIMO filter through the coefficient control of the coefficient control unit 35. However, in a case where there is a mode-dependent loss, interference between modes may not be completely cancelled in the first MIMO filter. In the present disclosure, the removal component generation unit 33 generates a signal component to be removed including an interference component generated between a plurality of modes from the output signal of the MIMO demodulation unit 31 using the second MIMO filter through the coefficient control of the coefficient control unit 35. The interference cancellation unit 34 removes the signal component to be removed generated by the removal component generation unit 33 from the signal of the predetermined time slot extracted by the signal extraction unit 32. In this way, even in a case where there is a mode-dependent loss, an interference component between modes can be removed from the MIMO demodulated signal, so that it is possible to alleviate degradation in performance caused by the mode-dependent loss.

Unlike the technique described in “DMD-unmanaged long-haul SDM transmission over 2500-km 12core×3-mode MC-FMF and 6300-km 3-mode FMF employing intermodal interference cancelling technique”, the signal processing according to the present disclosure does not require repetitive processing. Thus, the present disclosure can mitigate influence of a mode-dependent loss while suppressing a calculation amount as compared with “DMD-unmanaged long-haul SDM transmission over 2500-km 12core×3-mode MC-FMF and 6300-km 3-mode FMF employing intermodal interference cancelling technique”.

Hereinafter, example embodiments according to the present disclosure will be described in detail. In the following description and drawings, omission and simplification are made as appropriate for clarity of description. In each drawing, the same elements and the similar elements are denoted by the same reference numerals, and the repeated description is omitted as necessary.

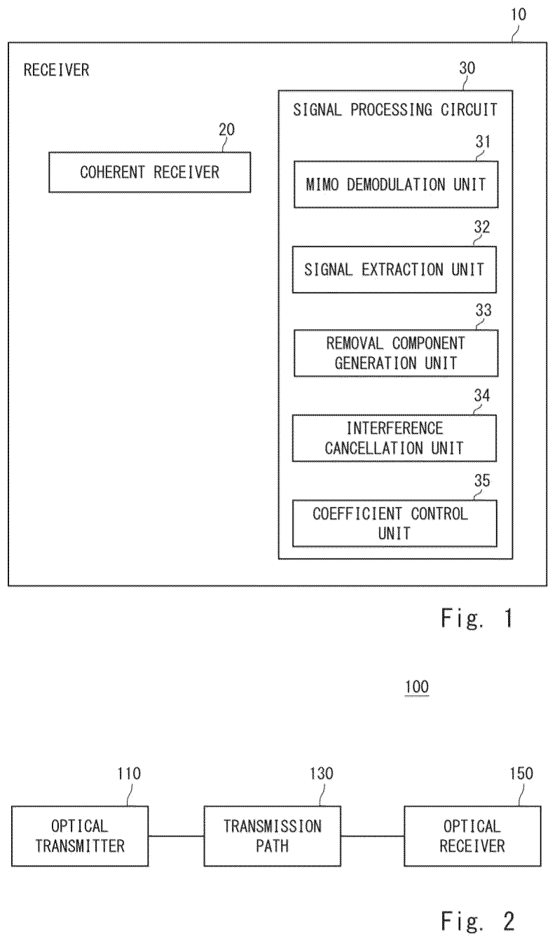

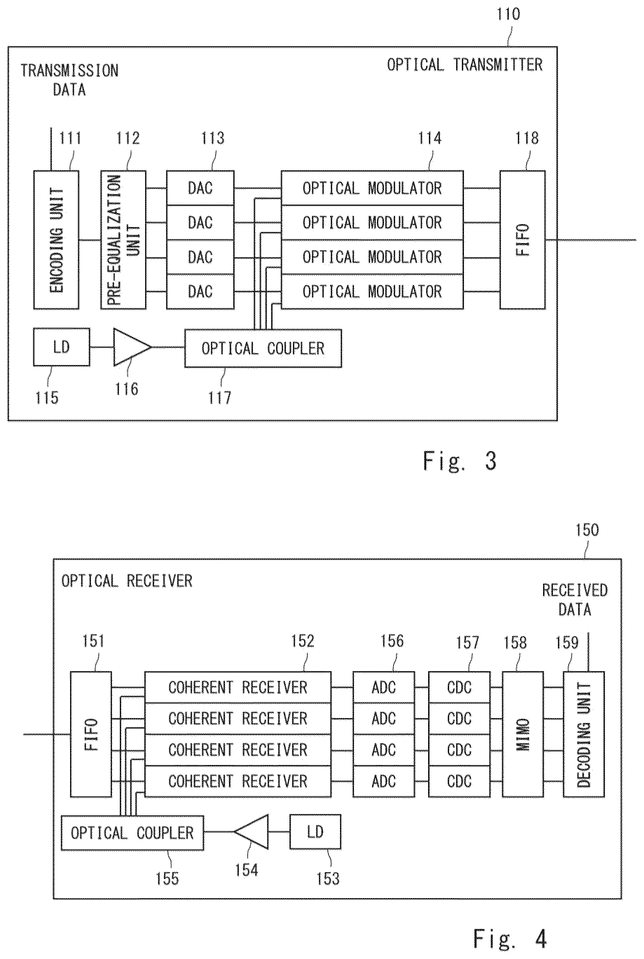

FIG. 2 is a block diagram illustrating a configuration example of a signal transmission system according to the present disclosure. FIG. 3 is a block diagram illustrating a configuration example of an optical transmitter. FIG. 4 is a block diagram illustrating a configuration example of an optical receiver. A signal transmission system in an example embodiment will be described below with reference to FIGS. 2 to 4. In an example embodiment, the signal transmission system is configured as an optical fiber communication system 100. The optical fiber communication system 100 includes an optical transmitter 110, a transmission path 130, and an optical receiver 150. The optical fiber communication system 100 constitutes, for example, an optical submarine cable system.

In an example embodiment, the optical fiber communication system 100 is configured as a coupled spatial multiplexing optical transmission system. Hereinafter, an example in which the optical fiber communication system 100 is a spatial multiplexing optical transmission system using a four-core coupled multicore fiber will be described. An example in which a quadrature amplitude modulation (QAM) scheme is adopted as a modulation scheme of a signal to be transmitted and received in the optical fiber communication system 100 and an optical signal is coherently received will be described. In this case, optical signals are multiplexed in a total of eight modes using two polarization modes and four spatial modes (cores). Although the spatial multiplexing technique can be used together with a wavelength multiplexing technique, an optical transmission system of one wavelength channel will be described below for simplification. Within the optical transmitter 110 and the optical receiver 150, in order to use existing technologies and devices for the SMF optical transmission system, a configuration for separating spatial modes is adopted.

The optical transmitter 110 converts transmission data into a plurality of optical signals to be multiplexed by spatial multiplexing and polarization multiplexing. The optical transmitter 110 generates, for example, four polarization multiplexed optical signals. The optical transmitter 110 spatially multiplexes the four polarization multiplexed optical signals and outputs the resultant signals to the transmission path 130. The transmission path 130 includes, for example, a spatially multiplexed optical fiber such as a coupled four-core fiber. In addition, the transmission path 130 includes a multicore fiber optical amplifier that compensates for propagation loss in a multicore fiber. The optical receiver 150 receives a plurality of polarization multiplexed optical signals via the transmission path 130.

The optical transmitter 110 includes an encoding unit 111, a pre-equalization unit 112, a digital analog converter (DAC) 113, an optical modulator 114, a laser diode (LD) 115, an optical amplifier 116, an optical coupler 117, and a FIFO device 118.

The encoding unit 111 encodes transmission data and converts the transmission data into a signal in a predetermined modulation format. For example, the encoding unit 111 maps the transmission data to a QAM signal. The pre-equalization unit 112 performs pre-equalization for compensating for distortion in the transmitter on the converted transmission data. The DAC 113 converts the pre-equalized data from a digital signal to an analog electrical signal. In a general coherent optical transmission system, a modulation format having an in-phase (I) component and a quadrature (Q) component is adopted. Thus, the DAC 113 outputs a total of four systems of analog electric signals corresponding to each of the I component and the Q component of two polarized waves for each spatial mode. In FIG. 3, for the sake of simplicity, signals of four systems output from the DAC 113 are represented by one line.

The LD 115 which is a laser light source outputs continuous-wave (CW) light. The optical amplifier 116 amplifies the CW light. The optical coupler 117 outputs the amplified CW light to the optical modulator 114. The optical modulator 114 is a polarization multiplexing type optical modulator. The optical modulator 114 modulates the CW light input from the optical coupler 117 with the analog electric signal output from the DAC 113 for each spatial mode to generate a polarization multiplexed optical signal. The FIFO device 118 outputs the polarization multiplexed optical signal generated for each spatial mode to the transmission path 130 including the multicore fiber. The FIFO device 118 guides the plurality of polarization multiplexed optical signals to each core of the multicore fiber of the transmission path 130.

The optical receiver 150 includes a FIFO device 151, a coherent receiver 152, an LD 153, an optical amplifier 154, an optical coupler 155, an analog digital converter (ADC) 156, a chromatic dispersion compensation (CDC) filter 157, a MIMO signal processing circuit 158, and a decoding unit 159. In the optical receiver 150, circuits such as the CDC filter 157, the MIMO signal processing circuit 158, and the decoding unit (decoder) 159 can be configured using devices such as a digital signal processor (DSP). The optical receiver 150 corresponds to the receiver 10 illustrated in FIG. 1.

The optical receiver 150 receives the optical signal transmitted from the optical transmitter 110 via the transmission path 130. In the optical receiver 150, the FIFO device 151 separates the received optical signal for each mode. The FIFO device 151 outputs the separated optical signal for each mode to the coherent receiver 152 arranged for each mode. The optical signal is generally separated for each spatial channel, that is, core. In FIG. 4, for simplification, it is assumed that the optical signal is separated for each core. The coherent receiver 152 corresponds to the coherent receiver 20 illustrated in FIG. 1.

The LD 153 outputs CW light. The optical amplifier 154 amplifies the CW light. The optical coupler 155 outputs the amplified CW light to the coherent receiver 152. The coherent receiver 152 coherently receives the optical signal separated by the FIFO device 151 using the CW light input from the optical coupler 155 for each spatial mode. The coherent receiver 152 converts the optical signal into a total of four systems of electrical signals corresponding to an I component and a Q component of two polarized waves for each spatial mode. The ADC 156 converts the coherently received signal into a digital signal.

The optical receiver 150 performs digital signal processing on the signal converted into a digital domain. In the digital signal processing, the CDC filter 157 performs static wavelength dispersion compensation on the received signal for each spatial mode. The digital signal processing may include matched filtering, compensation for static receiver device imperfection, and compensation for frequency offset of a transmission light source and local oscillator light. In addition, the digital signal processing includes synchronization with a known training signal for applying a data-aided adaptive MIMO filter, that is, correction of a delay amount common to the spatial modes.

The MIMO signal processing circuit 158 performs processing including MIMO demodulation processing on the signal subjected to the wavelength dispersion compensation. The decoding unit 159 performs decoding processing including symbol determination and error correction on the output of the MIMO signal processing circuit 158, and outputs received data obtained by restoring the transmission data.

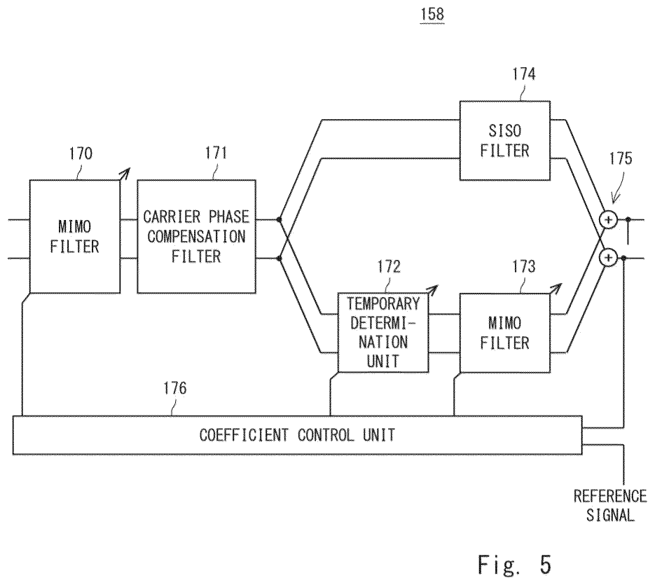

FIG. 5 is a block diagram illustrating a configuration example of the MIMO signal processing circuit 158. The MIMO signal processing circuit 158 includes a MIMO filter 170, a carrier phase compensation filter 171, a temporary determination unit 172, a MIMO filter 173, a single-input single-output (SISO) filter 174, an adder 175, and a coefficient control unit 176. In FIG. 5, for simplification of the drawing, signal processing in the MIMO signal processing circuit 158 will be described as 2×2 MIMO signal processing. At least some of the functions of the MIMO signal processing circuit 158, particularly at least some of the functions of the temporary determination unit 172 and the coefficient control unit 176, can be implemented by at least one processor executing processing in accordance with a command read from at least one memory. The MIMO signal processing circuit 158 corresponds to the signal processing circuit 30 illustrated in FIG. 1.

In the configuration illustrated in FIG. 5, two systems of the received signals corresponding to the respective spaces and polarization modes on the receiver side are input to the MIMO filter 170. The MIMO filter 170 performs MIMO signal processing on the two systems of the received signals. The MIMO filter 170 includes, for example, a time-domain FIR filter. It is assumed that the input signal of the MIMO filter 170 is a signal subjected to 2-times oversampling, and the output signal of the MIMO filter 170 is a signal subjected to 1-time oversampling. The MIMO filter 170 is also referred to as a first MIMO filter.

The carrier phase compensation filter 171 performs carrier phase compensation on the output signal of the MIMO filter 170. The carrier phase compensation filter 171 is also referred to as a carrier phase compensation unit. The carrier phase compensation filter 171 performs carrier phase compensation for each space and each polarization mode. A phase compensation amount in the carrier phase compensation filter 171 is determined from a final output of the MIMO signal processing circuit 158 using a phase lock loop (PLL) method. The output signal of the two systems of the carrier phase compensation filter 171 is branched into the temporary determination unit 172 and the SISO filter 174, respectively. The MIMO filter 170 and the carrier phase compensation filter 171 correspond to the MIMO demodulation unit 31 illustrated in FIG. 1.

An output signal vector of the carrier phase compensation filter 171, which is an output signal of the MIMO demodulation processing, is expressed by, for example, the following expression.

$${\tilde{z}}_{i} = {( {\tilde{z}}_{i} [ k ] , … , {\tilde{z}}_{i} [ k - {M}_{2} + 1 ] )}^{T} \qquad [ Math . 1 ]$$

In the above expression, i is an index representing a space and a polarization mode, and in a case where the number of modes is D, i=1, . . . , D. In a case of 2×2 MIMO, D=2. k is an index representing time. M₂ is a time spread of the output signal vector of the carrier phase compensation filter 171. The time spread of the output signal vector of the carrier phase compensation filter 171 corresponds to a time spread of the MIMO filter 173 and the SISO filter 174. T represents transposition.

The SISO filter 174 performs SISO filtering processing for each space and each polarization mode. The SISO filter 174 includes, for example, a time-domain FIR filter arranged for each space and each polarization mode. Coefficients of the SISO filter 174 are expressed by the following expression as M=M₂.

$${w}_{i}^{[ a ]} = {( {w}_{i}^{[ a ]} [ 0 ] , … , {w}_{i}^{[ a ]} [ M - 1 ] )}^{T} \qquad [ Math . 2 ]$$

An output signal of the SISO filter 174 is expressed by the following expression.

$${\overline{z}}_{i} = {w}_{i}^{[ a ] T} {\tilde{z}}_{i} \qquad [ Math . 3 ]$$

The SISO filter 174 extracts a signal of a desired time slot from the output signal vector of the carrier phase compensation filter 171 having a predetermined time spread. In the filter coefficients of the SISO filter 174, components of the time slot to be extracted are set to 1, and the other components are set to 0. For example, in the SISO filter 174, the coefficient of only a center tap is set to 1, and the coefficients of the remaining taps are set to 0. Specifically, the filter coefficients of the SISO filter 174 are expressed by, for example, the following expression.

$${w}_{i}^{[ a ]} = {( 0 , … , 0 , 1 , 0 , … , 0 )}^{T} \qquad [ Math . 4 ]$$

The SISO filter 174 corresponds to the signal extraction unit 32 illustrated in FIG. 1.

The temporary determination unit 172 determines a symbol of the output signal of the carrier phase compensation filter 171 for each space and each polarization mode. For symbol determination, soft decision processing or hard decision processing can be used. The symbol determination in the temporary determination unit 172 is symbol determination to be performed on a signal in the middle of signal processing, unlike final symbol determination in the decoding unit 159. In this sense, the symbol determination in the temporary determination unit 172 is also referred to as temporary determination. The output signal vector of the temporary determination unit 172 is expressed by, for example, the following expression.

$${\hat{x}}_{i} = {( {\hat{x}}_{i} [ k ] , … , {\hat{x}}_{i} [ k - {M}_{2} + 1 ] )}^{T} \qquad [ Math . 5 ]$$

In a case where the hard decision processing is used for the temporary determination, the temporary determination unit 172 determines the input output signal vector of the carrier phase compensation filter 171 as a transmission symbol candidate for each element using a method such as a least square distance. If a function representing this determination processing is denoted by d, the symbol determination can be expressed by the following expression.

$${\hat{x}}_{i} [ k ] = d ( {\tilde{z}}_{i} [ k ] ) \qquad [ Math . 6 ]$$

In a case where soft decision processing is used for the temporary determination, the temporary determination unit 172 performs soft decision on the input output signal vector of the carrier phase compensation filter 171 for each element. For example, the temporary determination unit 172 divides the output signal of the carrier phase compensation filter 171 into a real part and an imaginary part as

$${\tilde{z}}_{i} [ k ] = {\tilde{z}}_{i I} [ k ] + i {\tilde{z}}_{i Q} [ k ] \qquad [ Math . 7 ]$$

and performs soft decision on the symbol using the following expression.

$${\hat{x}}_{i} [ k ] = ( tanh ( {β}_{i} {\tilde{z}}_{iI} [ k ] ) + i tanh ( {β}_{i} {\tilde{z}}_{iQ} [ k ] ) ) / \sqrt{2} \qquad [ Math . 8 ]$$

In the above expression, βᵢ is a parameter of an adjustable real number. Extension to a multi-valued QAM signal can be configured by using a plurality of tanh. The temporary determination unit 172 is also referred to as a symbol determination unit.

The MIMO filter 173 performs MIMO signal processing on the result of the temporary determination by the temporary determination unit 172. The MIMO filter 173 includes a time-domain FIR filter. The filter coefficients of the MIMO filter 173 are expressed by, for example, the following expression.

$${w}_{i j}^{[ b ]} = {( {w}_{i j}^{[ b ]} [ 0 ] , … , {w}_{i j}^{[ b ]} [ M - 1 ] )}^{T} \qquad [ Math . 9 ]$$

In the above expression, i and j are indexes representing a space and a polarization mode. An output signal of the MIMO filter 173 is expressed by the following expression.

$${\check{z}}_{i} = {\sum }_{j = 1}^{D} {w}_{ij}^{[ b ] T} {\hat{x}}_{j} \qquad [ Math . 10 ]$$

The MIMO filter 173 generates a signal component to be removed including an interference component between modes included in the output signal output from the carrier phase compensation filter 171 from the signal temporarily determined by the temporary determination unit 172. In this regard, among diagonal components

$${w}_{ii}^{[ b ]} \qquad [ Math . 11 ]$$

of the coefficients of the MIMO filter 173, elements at positions where the coefficients are “1” in the SISO filter 174 are fixed to 0. The temporary determination unit 172 and the MIMO filter 173 correspond to the removal component generation unit 33 illustrated in FIG. 1. The MIMO filter 173 is also referred to as a second MIMO filter.

The adder 175 adds the output signal of the MIMO filter 173 and the output signal of the SISO filter 174 for each space and each polarization mode. In other words, the adder 175 removes the signal component to be removed output from the MIMO filter 173 from the signal of the predetermined time slot extracted by the SISO filter 174 for each space and each polarization mode. The signal added by the adder 175 is output as the output signal of the MIMO signal processing circuit 158. A final output signal of the MIMO signal processing circuit 158 output from the adder 175 is expressed by the following expression.

$${\overline{z}}_{i} + {\check{z}}_{i} \qquad [ Math . 12 ]$$

The adder 175 corresponds to the interference cancellation unit 34 illustrated in FIG. 1.

The coefficient control unit 176 adaptively controls the filter coefficients of the MIMO filter 170 and the filter coefficients of the MIMO filter 173 based on the output signal of the MIMO signal processing circuit 158 and a reference signal, that is, a desired signal. For updating the coefficients, a stochastic gradient descent method and an error back propagation method are used. The coefficient control unit 176 updates the filter coefficients of the MIMO filter 170 and the filter coefficients of the MIMO filter 173 using the stochastic gradient descent method and the error back propagation method in such a way as to minimize a difference between the output signal of the MIMO signal processing circuit 158 and the reference signal. However, as described above, the coefficient control unit 176 fixes the elements corresponding to the taps having coefficients of “1” in the SISO filter 174 to 0 among the diagonal components of the coefficients of the MIMO filter 173. In a case where the soft decision processing is used for the temporary determination, the coefficient control unit 176 also updates internal parameters in the soft decision processing using the stochastic gradient descent method and the error back propagation method.

The coefficient control using the error back propagation and the gradient descent method of the FIR filter including the time spread configured in multiple layers as illustrated in FIG. 5 is studied in M. Arikawa et al., “Compensation and monitoring of transmitter and receiver impairments in 10,000-km single-mode fiber transmission by adaptive multi-layer filters with augmented inputs”, Opt. Express 30 (12), 20333 (2022), and the like. However, in “Compensation and monitoring of transmitter and receiver impairments in 10,000-km single-mode fiber transmission by adaptive multi-layer filters with augmented inputs”, error back propagation of temporary determination processing is not included. Hereinafter, the error back propagation of the temporary determination processing in the temporary determination unit 172 will be described. For simple branching and addition, error back propagation can be easily derived.

A loss function to be minimized constituted by a final output using a method such as data-aided LMS or decision-directed LMS is defined as φ. The error back propagation of the temporary determination processing is processing of calculating, in a case where a gradient

$$\partial ϕ / \partial {\hat{x}}_{i} \qquad [ Math . 13 ]$$

related to the temporary determination output of the loss function φ is given, a gradient

$$\partial ϕ / \partial {\tilde{z}}_{i} \qquad [ Math . 14 ]$$

related to a temporary determination input of the loss function φ and a gradient

$$\partial ϕ / \partial {β}_{i} \qquad [ Math . 15 ]$$

related to internal parameters of the temporary determination of the loss function φ. In a case where the hard decision processing is used for the temporary determination, the gradient related to the internal parameters of the temporary determination of the loss function φ is set to “0”.

The gradient related to the temporary determination input of the loss function φ is calculated by the following expression based on a chain rule of differentiation.

$$\frac{\partial ϕ}{\partial {\tilde{z}}_{i}} = \frac{\partial ϕ}{\partial {\hat{x}}_{i}} ◦ \frac{{β}_{i}}{2 \sqrt{2}} ( \frac{1}{{cosh}^{2} ( {β}_{i} {\tilde{z}}_{i I} )} + \frac{1}{{cosh}^{2} ( {β}_{i} {\tilde{z}}_{iQ} )} ) + \frac{\partial ϕ}{\partial {\hat{x}}_{i}^{*}} ◦ \frac{{β}_{i}}{2 \sqrt{2}} ( \frac{1}{{cosh}^{2} ( {β}_{i} {\tilde{z}}_{i I} )} - \frac{1}{{cosh}^{2} ( {β}_{i} {{\tilde{z}}_{i}}_{Q} )} ) \qquad [ Math . 16 ]$$

In the above expression, * represents a complex conjugate, and ◯ represents a Hadamard product.

Similarly, the gradient related to the internal parameters of the temporary determination of the loss function o is calculated by the following expression based on the chain rule of differentiation.

$$\frac{\partial ϕ}{\partial {β}_{i}} = {\sum }_{m = 0}^{M - 1} \frac{\partial ϕ}{\partial \hat{{x}_{i}} [ k - m ]} \frac{1}{\sqrt{2}} \text{} ( \frac{{\tilde{z}}_{iI} [ k - m ]}{{cosh}^{2} ( {β}_{i} {\tilde{z}}_{iI} [ k - m ] )} + i \frac{{\tilde{z}}_{i Q} [ k - m ]}{{cosh}^{2} ( {β}_{i} {\tilde{z}}_{i Q} [ k - m ] )} ) + c . c . \qquad [ Math . 17 ]$$

In the above expression, c.c. represents a complex conjugate term.

The coefficient control unit 176 updates the filter coefficients of the MIMO filter 170 and the filter coefficients of the MIMO filter 173 using the error back propagation of the temporary determination processing described above and the coefficient control described in “Compensation and monitoring of transmitter and receiver impairments in 10,000-km single-mode fiber transmission by adaptive multi-layer filters with augmented inputs”. Furthermore, the coefficient control unit 176 updates the internal parameters (in a case of soft decision processing) of the temporary determination unit 172. In other words, the coefficient control unit 176 updates the coefficients of the MIMO filter 170, the coefficients of the MIMO filter 173, and the internal parameters of the temporary determination unit 172 using error back propagation and the gradient descent method in such a way as to minimize a magnitude of a difference between the final output and the desired signal. In the calculation of the gradient using the error back propagation, an intermediate result such as an output signal of the MIMO filter 170 for calculating the final output, which is not illustrated for readability in FIG. 5, is used. In addition, under the assumption that an element at a certain time position of the filter coefficient always takes a significant value, only a contribution (for example, contribution from k-p to k-q time position) between elements taking a significant value among gradients calculated using the error back propagation may be calculated.

As a specific example, a case where tap lengths of the MIMO filter 173 and the SISO filter 174 are 1 will be considered. In this case, the time spread of the output signal of the carrier phase compensation filter 171 to be used for generating the 1-symbol output signal of the MIMO signal processing circuit 158, that is, a vector length of the output signal vector is “1”. The coefficients of the SISO filter 174 are expressed by the following expression.

$$\begin{matrix}{w}_{1}^{[ a ]} = 1 \\ {w}_{2}^{[ a ]} = 1\end{matrix} \qquad [ Math . 18 ]$$

In this case, the SISO filter 174 outputs an output signal

$$\begin{matrix}{\overline{z}}_{1} = {\tilde{z}}_{1} [ k ] \\ {\overline{z}}_{2} = {\tilde{z}}_{2} [ k ]\end{matrix} \qquad [ Math . 19 ]$$

of the carrier phase compensation filter 171 as it is.

The filter coefficients of the MIMO filter 173 are expressed by the following expression because the coefficients of the elements corresponding to the taps in which the coefficients of the SISO filter 174 are 1 are fixed to 0 in the diagonal components.

$${w}^{[ b ]} = ( \begin{matrix}0 & {w}_{12}^{[ b ]} [ 0 ] \\ {w}_{21}^{[ b ]} [ 0 ] & 0\end{matrix} ) \qquad [ Math . 20 ]$$

In this case, the output signal of the MIMO filter 173 is expressed by the following expression.

$$\begin{matrix}{\check{z}}_{1} = {w}_{12}^{[ b ]} [ 0 ] {\hat{x}}_{2} [ k ] \\ {\check{z}}_{2} = {w}_{21}^{[ b ]} [ 0 ] {\hat{x}}_{1} [ k ]\end{matrix} \qquad [ Math . 21 ]$$

The output signal of the MIMO signal processing circuit 158 output from the adder 175 is expressed by the following expression.

$$\begin{matrix}{\overline{z}}_{1} + {\check{z}}_{1} = {\tilde{z}}_{1} [ k ] + {w}_{12}^{[ b ]} [ 0 ] {\hat{x}}_{2} [ k ] \\ {\overline{z}}_{2} + {\check{z}}_{2} = {\tilde{z}}_{2} [ k ] + {w}_{21}^{[ b ]} [ 0 ] {\hat{x}}_{1} [ k ]\end{matrix} \qquad [ Math . 22 ]$$

The second term on the right side of the above expression indicates an interference component caused by a signal of another mode to be removed from the signal after carrier phase compensation. The coefficient control unit 176 updates the coefficients of the MIMO filter 170 and the coefficients of the MIMO filter 173 using the error propagation method and the gradient descent method in such a way as to minimize a difference between the output signal of the MIMO signal processing circuit 158 and the desired reference signal expressed by the above equation. In this way, interference components of other modes remaining in the signal after the carrier phase compensation can be removed.

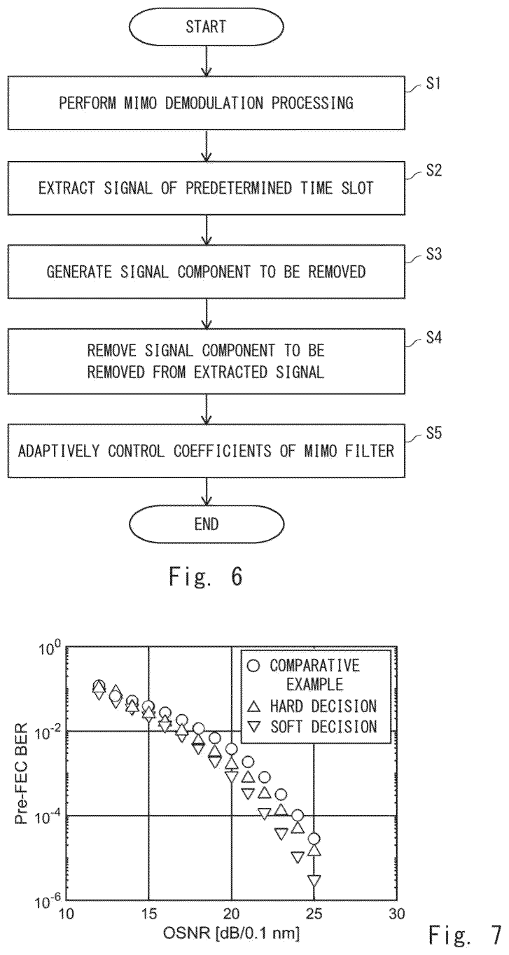

Next, operation procedure for obtaining an output of one symbol period will be described. FIG. 6 is a flowchart indicating operation procedure of the MIMO signal processing circuit 158. The operation procedure indicated in FIG. 6 corresponds to the signal processing method. In the MIMO signal processing circuit 158, the MIMO filter 170 and the carrier phase compensation filter 171 perform MIMO demodulation processing on a plurality of signals corresponding to a plurality of modes (step S1). In step S1, the MIMO filter 170 compensates for coupling between modes and mode dispersion occurring in a plurality of input signals, and separates a plurality of signals multiplexed by spatial multiplexing, for example, in the transmission path 130. The carrier phase compensation filter 171 performs carrier phase compensation on the separated signals. The carrier phase compensation filter 171 outputs the signal subjected to the carrier phase compensation of each mode to the SISO filter 174 and the temporary determination unit 172.

The SISO filter 174 extracts a signal of a predetermined time slot from the output signal of the MIMO demodulation processing output from the carrier phase compensation filter 171. The temporary determination unit 172 and the MIMO filter 173 generate a signal component to be removed based on the output signal of the MIMO demodulation processing output from the carrier phase compensation filter 171 (step S3). In step S3, the temporary determination unit 172 temporarily determines a symbol for the output signal of the carrier phase compensation filter 171. The MIMO filter 173 performs MIMO signal processing on the signal representing the temporarily determined symbol, and generates a signal component to be removed including an interference component between modes.

The adder 175 adds the output signal of the SISO filter 174 and the output signal of the MIMO filter 173 to remove the generated signal component to be removed from the extracted signal of the predetermined time slot (step S4). The coefficient control unit 176 adaptively controls the coefficients of the MIMO filter 170 and the coefficients of the MIMO filter 173 using the error back propagation method and the gradient descent method (step S5). In step S5, the coefficient control unit 176 calculates a difference between the output signal of the adder 175 and the desired reference signal as a loss function, and controls the coefficients of the MIMO filter 170 and the coefficients of the MIMO filter 173 in such a way as to minimize the loss function. In the MIMO signal processing circuit 158, steps S1 to S5 are performed every symbol period. Note that steps S2 and S3 can be executed in parallel. Step S5 does not necessarily need to be performed every symbol period.

In an example embodiment, the MIMO filter 170 separates the signals transmitted in the plurality of modes for each mode, and the carrier phase compensation filter 171 performs carrier phase compensation on the signal in each separated mode. The signal after carrier phase compensation is branched into the temporary determination unit 172 and the SISO filter 174. The SISO filter 174 extracts a signal of a predetermined time slot. The temporary determination unit 172 temporarily determines a symbol for the signal after the carrier phase compensation. The MIMO filter 173 generates a signal component to be removed from the signal of the predetermined time slot using the result of the temporary determination of the symbol. The adder 175 outputs a sum of the output signal of the SISO filter 174 and the output signal of the MIMO filter 173 as an output signal of the MIMO signal processing circuit 158.

In one example embodiment, the coefficient control unit 176 updates the coefficients of the MIMO filter 170 and the coefficients of the MIMO filter 173 using the error back propagation method and the gradient descent method in such a way as to minimize a difference between the output signal of the adder 175 and the desired reference signal. In this way, an interference component between the modes remaining in the signal after the carrier phase compensation in the MIMO filter 173 can be generated as the signal component to be removed, and the interference component between the modes can be removed from the signal after the carrier phase compensation. In the present example embodiment, unlike K. Shibahara et al., “DMD-unmanaged long-haul SDM transmission over 2500-km 12core×3-mode MC-FMF and 6300-km 3-mode FMF employing intermodal interference cancelling technique,” Journal of Lightwave Technology 37 (1), 138 (2019), repetitive processing is not necessary. Thus, degradation in performance caused by the mode-dependent loss can be alleviated without greatly increasing a calculation amount.

The present inventors verified the operation of the MIMO signal processing according to the example embodiment by simulation. In the simulation, the coupled 4-core fiber transmission was performed on a polarization multiplexed quadrature phase shift keying (QPSK) signal of 32 Gbaud. In the transmission, coupling by a random unitary matrix and a mode-dependent loss of 5 dB were simulated. Thereafter, additive white Gaussian noise (AWGN) was added to the signal, and an optical signal-to-noise ratio (OSNR) was set. Such a signal was coherently received and oversampled with 2-times oversampling. A line width of laser was 100 kHz on both the transmitter side and the receiver side, and phase change was common to all the cores. MIMO signal processing was applied to the sampled signal after performing frame synchronization and frequency offset compensation using strength normalization, matched filtering, and cross-correlation.

In the simulation, carrier phase compensation using a 21 tap time-domain adaptive MIMO filter and a PLL was evaluated as existing MIMO signal processing for comparison. In the evaluation of the MIMO signal processing according to the example embodiment, the time length of the MIMO filter 170 was set to 21 taps, and the time length of the MIMO filter 173 was set to 1 tap. In both the existing MIMO signal processing and the MIMO signal processing according to the example embodiment, the loss function was first set as data-aided LMS, and after the adaptive coefficient control was substantially converged, the loss function was switched to decision-directed LMS. A bit error rate (BER) before error correction averaged in the space and the polarization mode of the output of the MIMO signal processing after switching to the decision-directed LMS was evaluated.

FIG. 7 is a graph indicating an evaluation result of the BER in a case where the OSNR is changed with the mode-dependent loss of 5 dB. In the graph indicated in FIG. 7, a horizontal axis represents the set OSNR, and a vertical axis represents the BER before the error correction averaged in the space and the polarization mode. In the evaluation of the MIMO signal processing in one example embodiment, a case of using the hard decision for the temporary determination and a case of using the soft decision for the temporary determination were evaluated. As indicated in FIG. 7, in the MIMO signal processing according to the example embodiment, both in a case of using the hard decision processing and in a case of using the soft decision processing for the temporary determination, the BER was improved as compared with the existing MIMO signal processing, and it has been confirmed that influence of the mode-dependent loss was alleviated.

In the above example embodiment, the example in which the MIMO signal processing circuit 158 is used in the coupled spatial multiplexing transmission system has been described. However, the present disclosure is not limited thereto. The MIMO signal processing circuit 158 can also be applied to other signal transmission systems in which signals are transmitted in a plurality of modes and a mode-dependent loss can occur in the plurality of modes.

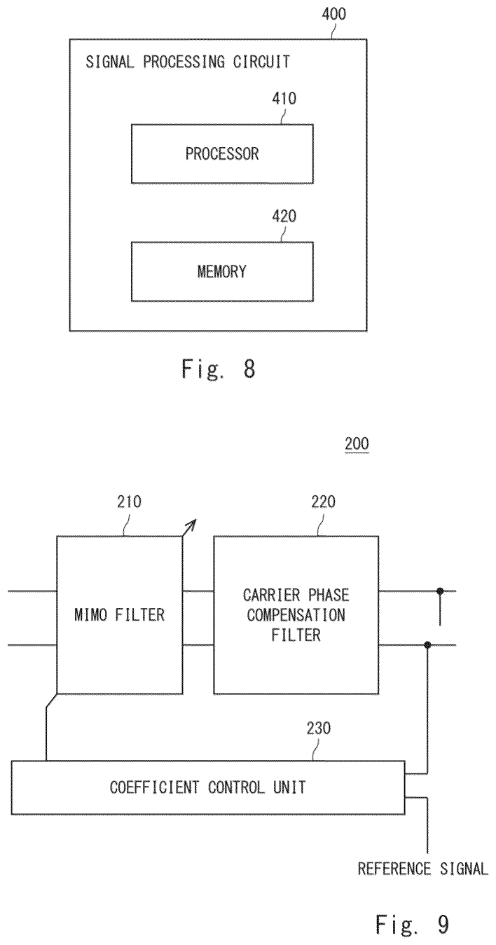

In the above example embodiment, the MIMO signal processing circuit 158 can be configured as an arbitrary digital signal processing circuit. FIG. 8 is a block diagram illustrating a configuration example of a signal processing circuit that can be used for the MIMO signal processing circuit 158. A signal processing circuit 400 includes one or more processors 410 and one or more memories 420. The processor 410 reads a program stored in the memory 420 to perform processing such as MIMO filtering processing and coefficient update.

The program described above includes commands (or software codes) for causing the processor to perform one or more functions described in the example embodiments in a case where the program is read by the processor. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a compact disc (CD)-ROM, a digital versatile disc (DVD), a Blu-ray (registered trademark) disk or other optical disk storage, a magnetic cassette, a magnetic tape, a magnetic disk storage, or other magnetic storage devices. The program may be transmitted through a transitory computer-readable medium or a communication medium. As an example and not by way of limitation, the transitory computer-readable medium or the communication medium includes an electric signal, an optical signal, an acoustic signal, or any other form of propagation signal.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

Each of the drawings is merely an example to illustrate one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps shown in one or more other drawings, for example, to create example embodiments that are not explicitly shown or described. All of the features or steps shown in any one of the drawings for describing the exemplary example embodiments are not necessarily mandatory, and some features or steps may be omitted. The order of the steps described in any of the drawings may be changed as appropriate.

Some or all of the above example embodiments may also be described as the following Supplementary Notes, but are not limited to the following Supplementary Notes.

### [Supplementary Note 1]

A signal processing circuit including:
a MIMO demodulation unit that includes a first multi input multi output (MIMO) filter and performs MIMO demodulation processing on a plurality of signals corresponding to a plurality of modes;
a signal extraction unit that extracts a signal of a predetermined time slot from an output signal output from the MIMO demodulation unit;
a removal component generation unit that includes a second MIMO filter and generates a signal component to be removed including an interference component generated between the plurality of modes based on the signal output from the MIMO demodulation unit;
an interference cancellation unit that generates a signal in which the signal component to be removed has been removed from the signal extracted by the signal extraction unit; and
a coefficient control unit that adaptively controls coefficients of the first MIMO filter and coefficients of the second MIMO filter using an error back propagation method and a gradient descent method using a magnitude of a difference between the signal in which the signal component to be removed has been removed and a reference signal as a loss function.

### [Supplementary Note 2]

The signal processing circuit according to Supplementary Note 1, in which the signal extraction unit includes, for each of the plurality of modes, a single-input single-output (SISO) filter that extracts the signal of the predetermined time slot from the output signal.

### [Supplementary Note 3]

The signal processing circuit according to Supplementary Note 1 or 2, in which the coefficient control unit fixes coefficients of taps corresponding to the predetermined time slot in diagonal components of the coefficients of the second MIMO filter to 0.

### [Supplementary Note 4]

The signal processing circuit according to any one of Supplementary Notes 1 to 3, in which
the removal component generation unit further includes a symbol determination unit that determines a symbol of the output signal output from the MIMO demodulation unit, and
the second MIMO filter generates the signal component to be removed based on a determination result of the symbol.

### [Supplementary Note 5]

The signal processing circuit according to supplementary Note 4, in which the symbol determination unit determines the symbol of the signal output from the MIMO demodulation unit using soft decision processing.

### [Supplementary Note 6]

The signal processing circuit according to Supplementary Note 5, in which the coefficient control unit controls parameters in the soft decision processing using a gradient of the loss function, related to the output signal input to the symbol determination unit and a gradient of the loss function, related to the parameters in the soft decision processing.

### [Supplementary Note 7]

The signal processing circuit according to Supplementary Note 4, in which the symbol determination unit determines the symbol of the signal output from the MIMO demodulation unit using hard decision processing.

### [Supplementary Note 8]

The signal processing circuit according to any one of Supplementary Notes 1 to 7, in which the MIMO demodulation unit further includes a carrier phase compensation unit that performs carrier phase compensation on an output signal of the first MIMO filter.

### [Supplementary Note 9]

The signal processing circuit according to any one of Supplementary Notes 1 to 8, in which the interference cancellation unit includes an adder that outputs a sum of the signal extracted by the signal extraction unit and the signal component to be removed.

### [Supplementary Note 10]

The signal processing circuit according to any one of Supplementary Notes 1 to 9, in which the first MIMO filter compensates for coupling between the plurality of modes and mode dispersion occurring in the plurality of signals.

### [Supplementary Note 11]

The signal processing circuit according to any one of Supplementary Notes 1 to 10, in which the plurality of signals is obtained by coherently receiving signals spatially multiplexed in a plurality of spatial modes in a transmission path.

### [Supplementary Note 12]

The signal processing circuit according to Supplementary Note 11, in which the transmission path includes a coupled spatial multiplexing optical fiber.

### [Supplementary Note 13]

A receiver including:
the signal processing circuit according to any one of Supplementary Notes 1 to 12; and
a coherent receiver that coherently receives the plurality of signals.

### [Supplementary Note 14]

A signal processing method including:
performing, using a first multi input multi output (MIMO) filter, MIMO demodulation processing on a plurality of signals corresponding to a plurality of modes;
extracting a signal of a predetermined time slot from an output signal of the MIMO demodulation processing;
generating, using a second MIMO filter, a signal component to be removed including an interference component generated between the plurality of modes based on the output signal subjected to the MIMO demodulation processing;
generating a signal in which the signal component to be removed has been removed from the extracted signal; and
adaptively controlling coefficients of the first MIMO filter and coefficients of the second MIMO filter using an error back propagation method and a gradient descent method using a magnitude of a difference between the signal in which the signal component to be removed has been removed and a reference signal as a loss function.

### [Supplementary Note 15]

A program causing a processor to execute:
performing, using a first multi input multi output (MIMO) filter, MIMO demodulation processing on a plurality of signals corresponding to a plurality of modes;
extracting a signal of a predetermined time slot from an output signal of the MIMO demodulation processing;
generating, using a second MIMO filter, a signal component to be removed including an interference component generated between the plurality of modes based on the output signal subjected to the MIMO demodulation processing;
generating a signal in which the signal component to be removed has been removed from the extracted signal; and
adaptively controlling coefficients of the first MIMO filter and coefficients of the second MIMO filter using an error back propagation method and a gradient descent method using a magnitude of a difference between the signal in which the signal component to be removed has been removed and a reference signal as a loss function.

Some or all of the elements (for example, configurations and functions) described in Supplementary Notes 2 to 12 dependent on Supplementary Note 1 can also depend on Supplementary Notes 14 and 15 in a similar dependency relationship as Supplementary Notes 2 to 12. Some or all of the elements that have been described in any supplementary note are applicable to various types of hardware, software, recording means for recording software, systems, and methods.

1. A signal processing circuit comprising:
a MIMO demodulator that includes a first multi input multi output (MIMO) filter and performs MIMO demodulation processing on a plurality of signals corresponding to a plurality of modes;
a signal extractor that extracts a signal of a predetermined time slot from an output signal output from the MIMO demodulator;
a removal component generator that includes a second MIMO filter and generates a signal component to be removed including an interference component generated between the plurality of modes based on the signal output from the MIMO demodulator;
an interference canceller that removes the signal component to be removed from the signal extracted by the signal extractor;
at least one memory storing instructions; and
at least one processor configured to execute the instructions to adaptively control coefficients of the first MIMO filter and coefficients of the second MIMO filter using an error back propagation method and a gradient descent method using a magnitude of a difference between a signal in which the signal component to be removed has been removed and a reference signal as a loss function.

2. The signal processing circuit according to claim 1, wherein the signal extractor includes, for each of the plurality of modes, a single-input single-output (SISO) filter that extracts the signal of the predetermined time slot from the output signal.

3. The signal processing circuit according to claim 1, wherein the at least one processor is configured to execute the instructions to fix coefficients of taps corresponding to the predetermined time slot in diagonal components of the coefficients of the second MIMO filter to 0.

4. The signal processing circuit according to claim 1, wherein
the at least one processor is configured to execute the instructions to determine a symbol of the output signal output from the MIMO demodulator, and
the second MIMO filter generates the signal component to be removed based on a determination result of the symbol.

5. The signal processing circuit according to claim 4, wherein the at least one processor is configured to execute the instructions to determine the symbol of the signal output from the MIMO demodulator using soft decision processing.

6. The signal processing circuit according to claim 5, wherein the at least one processor is configured to execute the instructions to control parameters in the soft decision processing using a gradient of the loss function, related to the output signal on which the symbol determination is to be performed and a gradient of the loss function, related to the parameters in the soft decision processing.

7. The signal processing circuit according to claim 4, wherein the at least one processor is configured to execute the instructions to determine the symbol of the signal output from the MIMO demodulator using hard decision processing.

8. The signal processing circuit according to claim 1, wherein the MIMO demodulator further includes a carrier phase compensation filter that performs carrier phase compensation on an output signal of the first MIMO filter.

9. The signal processing circuit according to claim 1, wherein the interference canceller includes an adder that outputs a sum of the signal extracted by the signal extractor and the signal component to be removed.

10. The signal processing circuit according to claim 1, wherein the first MIMO filter compensates for coupling between the plurality of modes and mode dispersion occurring in the plurality of signals.

11. The signal processing circuit according to claim 1, wherein the plurality of signals is obtained by coherently receiving signals spatially multiplexed in a plurality of spatial modes in a transmission path.

12. The signal processing circuit according to claim 11, wherein the transmission path includes a coupled spatial multiplexing optical fiber.

13. A receiver comprising:
a coherent receiver that coherently receives a plurality of signals corresponding to a plurality of modes; and
a signal processing circuit, wherein
the signal processing circuit includes:
a MIMO demodulator that includes a first multi input multi output (MIMO) filter and performs MIMO demodulation processing on the plurality of signals;
a signal extractor that extracts a signal of a predetermined time slot from an output signal output from the MIMO demodulator;
a removal component generator that includes a second MIMO filter and generates a signal component to be removed including an interference component generated between the plurality of modes based on the signal output from the MIMO demodulator;
an interference canceller that removes the signal component to be removed from the signal extracted by the signal extractor;
at least one memory storing instructions; and
at least one processor configured to execute the instructions to adaptively control coefficients of the first MIMO filter and coefficients of the second MIMO filter using an error back propagation method and a gradient descent method using a magnitude of a difference between a signal in which the signal component to be removed has been removed and a reference signal as a loss function.

14. A signal processing method comprising:
performing, using a first multi input multi output (MIMO) filter, MIMO demodulation processing on a plurality of signals corresponding to a plurality of modes;
extracting a signal of a predetermined time slot from an output signal of the MIMO demodulation processing;
generating, using a second MIMO filter, a signal component to be removed including an interference component generated between the plurality of modes based on the output signal subjected to the MIMO demodulation processing;
generating a signal in which the signal component to be removed has been removed from the extracted signal; and
adaptively controlling coefficients of the first MIMO filter and coefficients of the second MIMO filter using an error back propagation method and a gradient descent method using a magnitude of a difference between the signal in which the signal component has been removed and a reference signal as a loss function.
